(19) United States
(12) Patent Application Publication
(10) Pub. No.: US 2011/0075959 A1
(43) Pub. Date: Mar. 31, 2011

(54) TAPERED ROLLER BEARING

(76) Inventor: Souta Koizumi, Shizuoka (JP)

(21) Appl. No.: 12/995,278

(22) PCT Filed: Jun. 15, 2009
(86) PCT No.: PCT/JP2009/060860

§ 371 Date: Nov. 30, 2010

(30) Foreign Application Priority Data
Jun. 16, 2008 (JP) 2008-156896

(51) Int. Cl. F16C 33/58

(52) U.S. Cl. 384/571

(57) ABSTRACT

To prevent abrasion of an end surface on a large flange portion side of an inner race and abrasion of an end surface of a flange portion of a mating member, a tapered roller bearing includes a washer fixed to the end surface on the large flange portion side of the inner race. A dimensional tolerance between the inner race and the washer, which is required when the washer is fixed to the inner race, is increased to reduce processing cost and to facilitate fixation work of the washer to the inner race. The tapered roller bearing includes a washer (5) fixed to an end surface (1d) on a large flange portion (1c) side of an inner race (1), in which an engagement recess portion (1c2) is provided in an outer peripheral surface (1c1) of the large flange portion (1c) of the inner race (1) and a plurality of elastically deformable claw portions (5b) are formed on an outer peripheral edge of the washer (5) and each provided with an engagement protruding portion (5b1) to be engaged with the engagement recess portion (1c2).

### TECHNICAL FIELD

The present invention relates to a tapered roller bearing incorporated into gear devices such as transmissions and differentials of automobiles.

### BACKGROUND ART

Conventional tapered roller bearings include the following as main components: an inner race having a conical raceway surface formed as an outer peripheral surface thereof, a small flange portion formed on a small diameter side of the raceway surface, and a large flange portion formed on a large diameter side of the raceway surface; an outer race having a conical raceway surface formed as an inner peripheral surface thereof; and a plurality of tapered rollers rollably interposed between the raceway surface of the inner race and the raceway surface of the outer race.

In the tapered roller bearings of this type, the inner race is fitted to a mating member (for example, drive pinion shaft or differential gear case of a differential) so that an end surface on a large flange portion side of the inner race (hereinafter, also referred to simply as inner-race end surface) is brought into contact with an end surface of a flange portion extending in a radial direction from the mating member (hereinafter, also referred to simply as flange end surface) and that the outer race is pressed to a flange end surface side. In this manner, an appropriate bearing preload is applied. By such application of the appropriate bearing preload, a fatigue life of the tapered roller bearing is prolonged and gears in a gear device such as a differential are more efficiently meshed with each other so that a trouble such as gear tooth chipping is prevented.

However, when a high torque is input to the gear device, distortion is generated in the mating member, with the result that stick-slip (slippage) occurs between the inner-race end surface and the flange end surface in some cases. In this case, in addition to generation of stick-slip noise, abrasion occurs on the inner-race end surface and the flange end surface. The abrasion occurring in this way on the inner-race end surface and the flange end surface causes the inner race to be separated from the outer race, with the result that the bearing preload is reduced.

Under such circumstance, as a technology for suppressing the abrasion of the inner-race end surface and the flange end surface so that the bearing preload is not reduced, for example, there has been provided a tapered roller bearing (roller bearing) as disclosed in Patent Literature 1 below. The tapered roller bearing includes a washer provided between the inner-race end surface and the flange surface for the purpose of prevention of the abrasion of both the end surfaces. In addition, the washer has a cylindrical portion formed on an outer peripheral edge thereof, and is integrated with the inner race by press fitting of the cylindrical portion to an outer peripheral surface of the large flange portion of the inner race.

### Citation List

Patent Literature: JP 2002-323049 A

### SUMMARY OF INVENTION

### Technical Problems

By the way, when the washer is used for suppressing the abrasion of the inner-race end surface and the flange end surface, it is significantly important, as described above, to integrate the inner race and the washer with each other in advance also in view of enhancement of workability at the time of transportation of the tapered roller bearing into an assembly process with respect to the mating member or at the time of actual assembly of the tapered roller bearing to the mating member after the transportation into the assembly process.

However, meanwhile, when the washer is press-fitted to the inner race as in the tapered roller bearing as disclosed in Patent Literature 1 for the purpose of integrating both the washer and the inner race with each other, it is essential to strictly control a dimensional tolerance of each of the washer and the inner race. This is because, unless the dimensional tolerances of both the washer and the inner race are strictly controlled, an accurate fixation force does not act on both the washer and the inner race, which leads to a problem in that the washer is easily separated from the inner race.

Under such circumstances, when the washer and the inner race are integrated with each other by press fitting, it is necessary to separately perform grinding or the like, for example, on an inner peripheral surface of the cylindrical portion of the washer and the outer peripheral surface of the large flange portion of the inner race so that dimensions of both the washer and the inner race are adjusted. As a result, a problem of a sharp increase in processing cost occurs.

In addition, when press fitting is performed, even when the dimensional tolerances of the washer and the inner race are successfully controlled with high accuracy, it is necessary to accurately position center axes of both the washer and the inner race to each other at the time of press fitting, and to press-fit the washer to the inner race, with the positional relation being maintained. Thus, assembly work of the washer and the inner race is extremely troublesome and complicated, which leads to a problem in that a manufacturing efficiency is markedly reduced.

The present invention has been made in view of the above-mentioned circumstances. It is a technical object of the present invention to provide a tapered roller bearing in which the washer is fixed to the end surface on the large flange portion side of the inner race thereof for the purpose of prevention of the abrasion of the end surface on the large flange portion side of the inner race and of the end surface of the flange portion of the mating member, the tapered roller bearing having the following advantages: a lower processing cost achieved by increase of the dimensional tolerances of the washer and the inner race, the dimensional tolerances being required at the time of fixation of the washer to the inner race; and facilitation of fixation work of the washer to the inner race.

### Solution to Problems

According to the present invention, which has been invented to solve the above-mentioned problem, a tapered roller bearing includes: an inner race having a conical raceway surface formed as an outer peripheral surface thereof, a small flange portion formed on a small diameter side of the raceway surface, and a large flange portion formed on a large diameter side of the raceway surface; an outer race having a conical raceway surface formed as an inner peripheral surface thereof; a plurality of tapered rollers rollably interposed between the raceway surface of the inner race and the raceway surface of the outer race; and a washer for preventing, under a state of being fixed to an end surface on a large flange portion side of the inner race, abrasion of the end surface on the large flange portion side of the inner race and abrasion of an end surface of a flange portion formed on a mating member internally fitted to the inner race, in which: the inner race includes an engagement recess portion provided in an outer peripheral surface of the large flange portion thereof; and the washer includes one or a plurality of elastically deformable claw portions formed on an outer peripheral edge thereof and each provided with an engagement protruding portion engaged with the engagement recess portion.

With this structure, the engagement recess portion of the outer peripheral surface of the large flange portion of the inner race and the engagement protruding portion of each of the claw portions of the washer are engaged with each other, with the result that the washer and the inner race can be integrated with each other. That is, as long as the engagement recess portion and the engagement protruding portion are engaged with each other, a gap may be formed between the outer peripheral surface of the large flange portion of the inner race and the claw portion. Thus, in comparison with the case where both the inner race and the claw portion are integrated with each other by press fitting, dimensional tolerances required at the time of fixation of both the inner race and the claw portion can be markedly increased. As a result, it is unnecessary any longer to perform grinding or the like for adjustment of the dimensional tolerances with high accuracy, and hence possible to achieve reduction of a manufacturing cost.

Further, when the washer is fixed to the inner race, the claw portion of the washer is elastically deformable, and hence the engagement protruding portion of the claw portion of the washer can be pushed into the outer peripheral surface of the large flange portion of the inner race even when a central axis of the inner race and a central axis of the washer are somewhat shifted from each other. That is, the elastic deformation of the claw portion of the washer to the radially outer side absorbs the shift of the central axes of the inner race and the washer. Thus, restriction on fixation work is markedly relaxed in comparison with the case where the inner race and the washer are press-fitted to each other. In addition, when reaching the position of corresponding to the engagement recess portion, the claw portion elastically deformed to the radially outer side restores to a radially inner side by an elastic restoring force, and hence the engagement protruding portion and the engagement recess portion can be semi-automatically engaged with each other. Thus, without forcible, troublesome, and complicated operations during the fixation work of the washer to the inner race, the engagement protruding portion and the engagement recess portion can be easily engaged with each other.

In the above-mentioned structure, it is preferred that the plurality of claw portions be provided at equal intervals along the outer peripheral edge of the washer.

With this, the claw portions of the washer are uniformly arranged around the outer peripheral surface of the large flange portion of the inner race. Thus, the washer and the inner race can be integrated with each other under a more stable state.

In the above-mentioned structure, it is preferred that the engagement recess portion be annularly formed over an entire periphery of the outer peripheral surface of the large flange portion of the inner race.

With this, regardless of the positions in a circumferential direction of the outer peripheral surface of the large flange portion of the inner race, from which the engagement protruding portion of the washer is pushed in, the engagement protruding portion and the engagement recess portion can be reliably engaged with each other.

In the above-mentioned structure, it is preferred that a tapered roller bearing further include a gap, under a state in which the engagement protruding portion and the engagement recess portion are engaged with each other, formed between a roller side of the engagement protruding portion and the engagement recess portion so that the roller side of the engagement protruding portion is kept out of contact with the engagement recess portion.

With this, the gap is formed between the roller side of the engagement protruding portion and the engagement recess portion. Thus, in a practical use aspect in which the mating member is internally fitted to the inner race, when the washer is pressed to the roller side by the flange portion of the mating member, the roller side of the engagement protruding portion is prevented from interfering with the engagement recess portion. Thus, the roller side of the engagement protruding portion does not interfere with the engagement recess portion and excessive stress concentration does not occur to the engagement protruding portion any longer. As a result, a stable engagement state of the engagement protruding portion and the engagement recess portion can be maintained.

In the above-mentioned structure, it is preferred that the engagement protruding portion be roundish.

With this, it is possible to reduce resistance generated when the engagement protruding portion is pushed into the outer peripheral surface of the large flange portion of the inner race. As a result, the engagement protruding portion is more easily pushed-in along the outer peripheral surface of the large flange portion of the inner race.

In the above-mentioned structure, it is preferred that the washer include a nitrided layer formed on a surface thereof.

This configuration is significantly advantageous in preventing the abrasion occurring on the end surface on the large flange portion side of the inner race and the end surface of the flange portion of the mating member internally fitted to the inner race. Further, appropriate toughness is imparted to the washer itself, and hence the elastic deformation of the above-mentioned claw portions can be more smoothly effected. That is, workability in the fixation work of the washer can be enhanced.

In the above-mentioned structure, it is preferred that the washer have a plate thickness of from 0.3 to 0.8 mm.

That is, when the washer has the plate thickness of less than 0.3 mm, the plate thickness of the washer is excessively small, which leads to deterioration of formability thereof. Meanwhile, when the washer has the plate thickness of 0.8 mm or larger, the plate thickness of the washer is excessively large, which leads to an increase in weight of the bearing at the time of fixation of the washer and to an increase in dimension of the bearing owing to the fixation of the washer. Accordingly, it is preferred that the plate thickness of the washer fall within the above-mentioned numerical range. With this setting, increase in weight of the bearing at the time of fixation of the washer and the increase in dimension of the bearing can be suppressed within a practically unproblematic range, and formability at the time of manufacturing of the washer can be satisfactorily maintained as well.

In the above-mentioned structure, it is preferred that B/A range from 0.9 to 2%, where A represents an inner diameter dimension of a part except the engagement protruding portion of the claw portion and B represents a maximum height of the engagement protruding portion.

That is, when B/A is 2% or more, the engagement protruding portion is excessively large relative to the inner diameter dimension of the claw portion (except the engagement protruding portion, being the same hereinafter in this paragraph). Thus, an elastic deformation amount of the claw portion at the time of fixation of the washer is increased, which may lead to deterioration of fixation properties in some cases. Meanwhile, when B/A is less than 0.9%, the engagement protruding portion is excessively small relative to the inner diameter dimension of the claw portion. Thus, hooking of the engagement protruding portion at the time of fixation of the washer to the inner race is too weak, with the result that a fixation force may be reduced in some cases. Accordingly, it is preferred that B/A fall within the above-mentioned numerical range. With this setting, the fixation properties of the washer and the fixation force of the washer after the fixation can be simultaneously enhanced.

In the above-mentioned structure, it is preferred that C/A range from 0 to 1.5%, where A represents the inner diameter dimension of the part except the engagement protruding portion of the claw portion and C represents a dimension of a gap between the part except the engagement protruding portion of the claw portion and the outer peripheral surface of the large flange portion of the inner race.

That is, when C/A is 1.5% or more, relative to the inner diameter dimension of the claw portion (except the engagement protruding portion, being the same hereinafter in this paragraph), the gap between the claw portion and the outer peripheral surface of the large flange portion of the inner race is excessively large. Thus, after fixation of the washer to the inner race, the washer wobbles with respect to the inner race in some cases. Accordingly, it is preferred that B/A fall within the above-mentioned numerical range. With this setting, the washer can be fixed in an appropriate posture, and the posture can be maintained.

In the above-mentioned structure, the mating member may include a pinion shaft of a differential.

### ADVANTAGEOUS EFFECTS OF INVENTION

According to the present invention, as described above, as long as the engagement recess portion provided to the outer peripheral surface of the large flange portion of the inner race and the engagement protruding portion provided to the claw portion of the washer are engaged with each other, the gap may be formed between the outer peripheral surface of the large flange portion of the inner race and the claw portion. Thus, in comparison with the case where both the inner race and the claw portion are integrated with each other by press fitting, the dimensional tolerances required at the time of fixation of both the inner race and the claw portion can be markedly increased. As a result, it is unnecessary any longer to perform grinding or the like for adjustment of the dimensional tolerances with high accuracy, and hence possible to achieve reduction of a manufacturing cost.

Further, at the time of fixation of the washer to the inner race, the elastic deformation of the elastically-deformable claw portion of the washer to the radially outer side absorbs the shift of the central axes of the inner race and the washer at the time of the fixation. Thus, restriction on fixation work is markedly relaxed in comparison with the case where the inner race is press-fitted to the washer. In addition, when reaching the position of corresponding to the engagement recess portion, the claw portion elastically deformed to the radially outer side restores to a radially inner side by an elastic restoring force, and hence the engagement protruding portion and the engagement recess portion can be semi-automatically engaged with each other. Thus, the washer can be easily fixed to the inner race so that both the washer and the inner race can be integrated with each other.

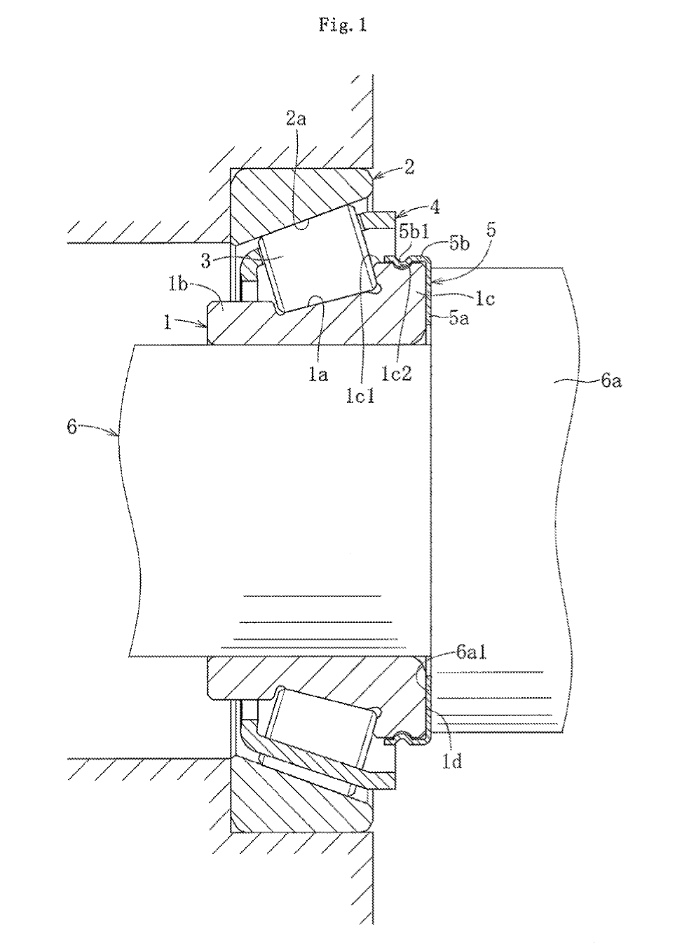

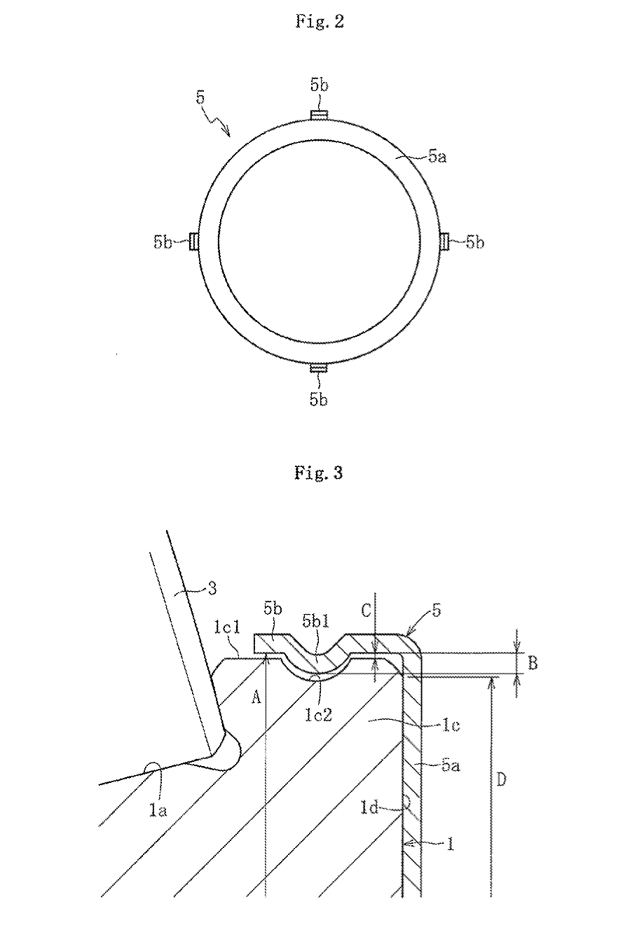

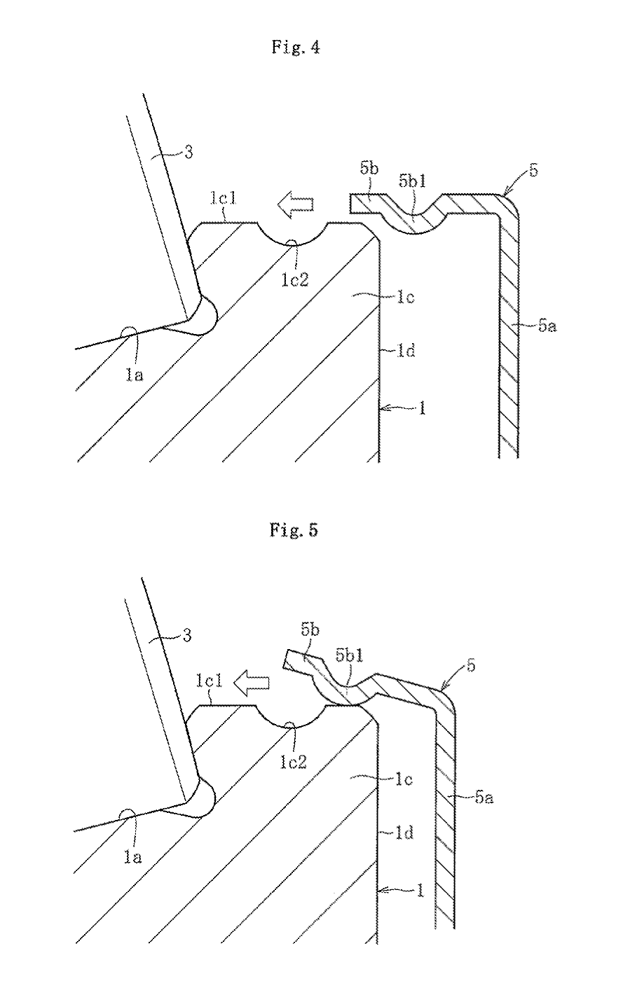

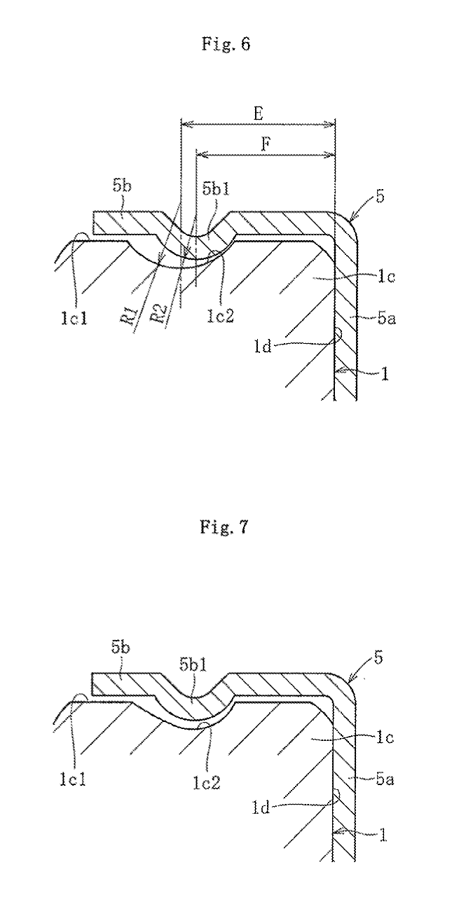

### BRIEF DESCRIPTION OF DRAWINGS

[FIG. 1] A vertical sectional view of a tapered roller bearing according to a first embodiment of the present invention.

[FIG. 2] A plan view of the washer illustrated in FIG. 1.

[FIG. 3] An enlarged vertical sectional view of the main portion of FIG. 1.

[FIG. 4] A view illustrating a procedure of fixing the washer onto an inner race.

[FIG. 5] Another view illustrating the procedure of fixing the washer onto the inner race.

[FIG. 6] An enlarged vertical sectional view of a main portion of a tapered roller bearing according to a second embodiment of the present invention.

[FIG. 7] An enlarged vertical sectional view of a main portion of a tapered roller bearing according to a modification of the second embodiment.

### DESCRIPTION OF EMBODIMENTS

In the following, description is made of embodiments of the present invention with reference to the drawings.

FIG. 1 is a vertical sectional view of a tapered roller bearing according to a first embodiment of the present invention. As illustrated in FIG. 1, the tapered roller bearing includes, as main components, an inner race 1, an outer race 2, and a plurality of tapered rollers 3.

The inner race 1 has a conical raceway surface 1a formed as an outer peripheral surface thereof, a small flange portion 1b formed on a small diameter side of the raceway surface 1a, and a large flange portion 1c formed on a large diameter side thereof.

The outer race 2 is arranged on an outer peripheral side of the inner race 1, and has a conical raceway surface 2a formed as an inner peripheral surface thereof and facing the raceway surface 1a of the inner race 1.

The plurality of tapered rollers 3 are rollably interposed between the raceway surface 1a of the inner race 1 and the raceway surface 2a of the outer race 2. Each of the tapered rollers 3 is retained by a retainer 4 at predetermined intervals in a circumferential direction of the bearing.

Further, the tapered roller bearing has a structural feature of including a steel-plate washer 5. The washer 5 is fixed to an end surface 1d on a large flange portion 1c side of the inner race 1, and functions to prevent abrasion of the inner-race end surface 1d and an end surface 6a1 of a flange portion 6a formed on a mating member 6 internally fitted to the inner race 1. Note that, in this embodiment, a nitrided layer is formed on a surface of the washer 5 for the purpose of preventing the abrasion. As a matter of course, in view of prevention of the abrasion, in place of or together with the nitrided layer, a solid lubricant layer may be formed on the surface of the washer 5.

Further, the washer 5 is made of a steel plate having a plate thickness of from 0.3 to 0.8 mm, and as illustrated in FIG. 2, includes a disk-like washer body 5a held in contact with the inner-race end surface 1d and a plurality of elastically deformable claw portions 5b provided on an outer peripheral edge of the washer body 5a at intervals in a circumferential direction (four in total at equal intervals in the circumferential direction in the illustration) . As illustrated in FIG. 3, each of the claw portions 5b extends along an outer peripheral surface 1c1 of the large flange portion 1c of the inner race 1 and includes an engagement protruding portion 5b1 provided near a distal end portion thereof and protruding to a radially inner side. Further, in this embodiment, the engagement protruding portion 5b1 has a roundish shape, and an engagement recess portion 1c2 engaged with the engagement protruding portion 5b1 is annularly formed over the entire periphery of the outer peripheral surface 1c1 of the inner race 1.

By pushing-in of the engagement protruding portion 5b1 of each of the claw portions 5b along the outer peripheral surface 1c1 of the large flange portion 1c of the inner race 1, the engagement protruding portion 5b1 is engaged with the engagement recess portion 1c2. In this case, after being elastically deformed to expand to a radially outer side, at a position of corresponding to the engagement recess portion 1c2, each of the claw portions 5b restores by an elastic restoring force to a position at which the engagement protruding portion 5b1 is engageable with the engagement recess portion 1c2.

That is, under a state in which the inner race 1 and the washer 5 are separated from each other as illustrated in FIG. 4, when the washer 5 is brought close to the inner race 1 so that the engagement protruding portion 5b1 of each of the claw portions 5b is pushed into the outer peripheral surface 1c1 of the large flange portion 1c of the inner race 1. Then, as illustrated in FIG. 5, the engagement protruding portion 5b1 climbs onto the outer peripheral surface 1c1 of the large flange portion 1c of the inner race 1 while being elastically deformed to the radially outer side of the claw portions 5b. Then, under this state, when the engagement protruding portion 5b1 of each of the claw portions 5b is further pushed into the outer peripheral surface 1c1 of the large flange portion 1c of the inner race 1, each of the claw portions 5b restores by the elastic restoring force to the radially inner side at the position of corresponding to the engagement recess portion 1c2. As a result, as illustrated in FIG. 3, the engagement protruding portion 5b1 is engaged with the engagement recess portion 1c2.

In this manner, the engagement recess portion 1c2 of the outer peripheral surface 1c1 of the large flange portion 1c of the inner race 1 and the engagement protruding portion 5b1 of each of the claw portions 5b of the washer 5 are engaged with each other, with the result that the washer 5 and the inner race 1 can be integrated with each other. Thus, as long as the engagement recess portion 1c2 and the engagement protruding portion 5b1 are engaged with each other, even when a gap is formed between the outer peripheral surface 1c1 of the large flange portion 1c of the inner race 1 and each of the claw portions 5b, the washer 5 remains to be hooked to the inner race 1. Accordingly, in comparison with a case where the washer 5 and the inner race 1 are integrated with each other by press fitting, dimensional tolerances required at the time of fixation of both the washer 5 and the inner race 1 can be markedly increased. As a result, it is no longer necessary to perform grinding as post processing on the washer 5 and the inner race 1, and hence a sharp increase in processing cost is prevented.

Further, when the washer 5 is fixed to the inner race 1, the claw portions 5b of the washer 5 are elastically deformable to the radially outer side, and hence the engagement protruding portion 5b1 of each of the claw portions 5b of the washer 5 can be pushed into the outer peripheral surface 1c1 of the large flange portion 1c of the inner race 1 even when a central axis of the inner race 1 and a central axis of the washer 5 are somewhat shifted from each other. That is, the elastic deformation of the claw portions 5b of the washer 5 to the radially outer side absorbs the shift of the central axes of the inner race 1 and the washer 5. Thus, restriction on fixation work is markedly relaxed in comparison with the case where the inner race 1 and the washer 5 are press-fitted to each other. In addition, at the position of corresponding to the engagement recess portion 1c2, each of the claw portions 5b elastically deformed to the radially outer side restores by the elastic restoring force to the position at which the engagement protruding portion 5b1 is engageable with the engagement recess portion 1c2, and hence the engagement protruding portion 5b1 is semi-automatically engaged with the engagement recess portion 1c2. Thus, the washer 5 can be easily fixed to the inner race 1 so that both the washer 5 and the inner race 1 can be integrated with each other.

Note that, as illustrated in FIG. 3, it is preferred that a dimensional relation between the washer 5 and the inner race 1 satisfy the following relations described below. That is, it is preferred that B/A range from 0.9 to 2.0%, C/A range from 0 to 1.5%, and Abe larger than D, where: A represents an inner diameter dimension of a part except the engagement protruding portion 5b1 of the claw portion 5b of the washer 5; B represents a maximum height of the engagement protruding portion 5b1 of the claw portion 5b of the washer 5; C represents a dimension of a gap between the part except the engagement protruding portion 5b1 of the claw portion 5b of the washer 5 and the outer peripheral surface of the large flange portion 1c of the inner race 1; and D represents a radially outer dimension of a flat surface portion of the end surface 1d on the large flange portion 1c side of the inner race 1. With this, the fixation work of the washer 5 can be effected with a force small enough for the fixation work to be manually effected. Thus, after the fixation, the washer 5 is more reliably prevented from being detached from the inner race 1 during a transportation process and the like prior to completion of incorporation of the mating member 6.

FIG. 6 is an enlarged vertical sectional view of a main portion of a tapered roller bearing according to a second embodiment of the present invention. The tapered roller bearing according to the second embodiment is different from the tapered roller bearing according to the first embodiment in an engagement state of the engagement protruding portion 5b1 and the engagement recess portion 1c2. That is, the difference therefrom of the tapered roller bearing according to the second embodiment is that a curvature radius R1 of the engagement recess portion 1c2 is set to be larger than a curvature radius R2 of the engagement protruding portion 5b1, and that an axial dimension E from a center curvature of the engagement recess portion 1c2 to the inner-race end surface 1d is set to be larger than an axial dimension F from a center curvature of the engagement protruding portion 5b1 to the inner-race end surface 1d. With this, under the state in which the engagement protruding portion 5b1 is engaged with the engagement recess portion 1c2, a gap is formed between a roller 3 side of the engagement protruding portion 5b1 and the engagement recess portion 1c2. Thus, the roller 3 side of the engagement protruding portion 5b1 is constantly kept out of contact with the engagement recess portion 1c2. Thus, even when the washer 5 is pressed to the roller 3 side, excessive stress generated by interference of the engagement protruding portions 5b1 with the engagement recess portion 1c2 is prevented from acting on the claw portions 5b, and hence a stable engagement state can be maintained.

Further, in this view, as illustrated in FIG. 7, the engagement recess portion 1c2 may be asymmetrically formed by cutting-out of the engagement recess portion 1c2 more on the roller 3 side than on an inner-race end surface 1d side so that the roller 3 side of the engagement protruding portion 5b1 is kept out of contact with the engagement recess portion 1c2.

### Examples

In order to verify the effectiveness of the present invention, evaluation tests were conducted. In detail, as a first example 1, there were prepared a plurality of SPCC washers which were of the same type as the washer described in the above-mentioned first embodiment and which were different from each other in dimensional ratios of B/A and C/A as illustrated in FIG. 3. Claw portions of each of the washers were pushed in an outer peripheral surface of a large flange portion of an inner race having an outer diameter dimension of 46 mm so that engagement protruding portions of the claw portions and engagement recess portions of the large flange portion were engaged each other. In this manner, the washers were fixed to inner-race end surfaces. Further, as a first comparison example, there was prepared a washer provided with, similarly to a conventional one, a cylindrical portion formed on an outer peripheral edge thereof, and the cylindrical portion of the washer was press-fitted to an outer peripheral surface of a large flange portion of an inner race having the outer diameter dimension of 46 mm which was the same as that of the above-mentioned inner race. In this manner, the washer was fixed to an inner-race end surface. Then, in the first example and the first comparison example, evaluations were made of magnitude of incorporating forces required at the time of fixation of the washers to the inner races and magnitude of fixation forces between the washer and the inner race after the fixation. Table 1 below shows the results of the evaluation.

In each cell, an evaluation result of the magnitude of the incorporating force is shown on an upper side and an evaluation result of the magnitude of the fixation force is shown on a lower side. Further, the evaluations of the incorporating forces were made based on the following evaluation criteria: 10 kgf or less of the magnitude of the incorporating force required for fixation was marked as “o”; more than 10 kgf and less than 20 kgf was marked as “Δ”; and 20 kgf or more was marked as “x.” Note that, manual incorporation is difficult when the incorporating force is 10 kgf or more, and manual incorporation without use of a machine is substantially impossible when the incorporating force is 20 kgf or more. In addition, special dedicated machines are required in many cases. Meanwhile, the evaluations of the fixation forces were made based on acceleration imparted to the washers fixed to the inner-race end surface: a case where the washer was not separated from the inner-race end surface even with acceleration of 2G or more was marked as “o”; a case where the washer was separated from the inner-race end surface with acceleration of less than 2G and 1G or more was marked as “Δ”; and a case where the washer was separated from the inner-race end surface with acceleration of less than 1G was marked as “x.” Note that, a force of 1G is a normal force considered to be generated when a tapered roller bearing is transported into an assembly process with respect to a mating member or when the tapered roller bearing is actually assembled to the mating member after the transportation into the assembly process, and a force of 2G is a maximum force considered to be generated at the time of such transportation and assembly.

TABLE 1

| | | | | | | | First |
|---|---|---|---|---|---|---|---|
| | | | | | | | comparison |
| First example | | | | | | | example |
| | | B/A [%] | | | | | X |
| | | 0.85 | 0.90 | 1.50 | 2.00 | 2.05 | ◯ |
| C/A [%] | 0.00 | Δ | Δ | Δ | Δ | Δ | |
| | | Δ | ◯ | ◯ | ◯ | ◯ | |
| | 0.30 | Δ | Δ | Δ | Δ | Δ | |
| | | Δ | ◯ | ◯ | ◯ | ◯ | |
| | 1.00 | Δ | ◯ | Δ | Δ | Δ | |
| | | Δ | ◯ | ◯ | ◯ | ◯ | |
| | 1.50 | ◯ | ◯ | Δ | Δ | Δ | |
| | | Δ | ◯ | ◯ | ◯ | ◯ | |
| | 1.80 | ◯ | ◯ | Δ | Δ | Δ | |
| | | Δ | Δ | Δ | Δ | Δ | |

Upper side: evaluation result of incorporating force,
Lower side: evaluation result of fixation force

Table 1 shows that, in the first comparison example, the incorporating forces of the washer were markedly large, that is, at a level that manual fixation could not be effected. Meanwhile, in the first example, the incorporating forces of all the washers were less than 20 kgf, and hence those results confirmed that an excessive incorporation force was not required at the time of fixation. Meanwhile, regarding the fixation forces between the washers and the inner races, press fitting was effected in the first comparison example, and hence satisfactory results were obtained. Also in the first example, none of the result shows that the fixation forces were less than 1G, and hence those results confirmed that a fixation force within a practically unproblematic range was secured. Thus, the results in the first example confirmed that reduction of the incorporating force and enhancement of the fixation force can be simultaneously achieved.

In addition, as a second example, there were prepared washers which were of the same type as the washers of the above-mentioned first example and on which nitriding treatment was performed so that a nitrided layer of 20 μm or more was formed on the washers. Evaluation tests same as those described in the first example were conducted, and Table 2 shows results of the tests. Note that, the evaluation criteria of the incorporating forces and the fixation forces were the same as the above-mentioned criteria.

TABLE 2
Second example

| | | B/A [%] | | | | |
|---|---|---|---|---|---|---|
| | | 0.85 | 0.90 | 1.50 | 2.00 | 2.05 |
| C/A [%] | 0.00 | ◯ | ◯ | ◯ | ◯ | Δ |
| | | Δ | ◯ | ◯ | ◯ | ◯ |
| | 0.30 | ◯ | ◯ | ◯ | ◯ | Δ |
| | | Δ | ◯ | ◯ | ◯ | ◯ |
| | 1.00 | ◯ | ◯ | ◯ | ◯ | Δ |
| | | Δ | ◯ | ◯ | ◯ | ◯ |
| | 1.50 | ◯ | ◯ | ◯ | ◯ | Δ |
| | | Δ | ◯ | ◯ | ◯ | ◯ |
| | 1.80 | ◯ | ◯ | ◯ | ◯ | Δ |
| | | Δ | Δ | Δ | Δ | Δ |

Upper side: evaluation result of incorporating force,
Lower side: evaluation result of fixation force

Table 2 shows that, in comparison with the first example, the second example provided a larger preferred range in which the evaluation results of both the incorporating forces and the fixation forces were marked as “o” (range in which B/A ranged from 0.90 to 2.00% and C/A ranged from 0.00 to 1.50%). This is probably due to appropriate toughness imparted to the washers by the nitriding treatment, which resulted in enlargement of a range in which the elastic deformation of the claw portions was smoothly effected. This also proves that, in view of reduction of the incorporating force of the washer so that the washer is easily fixed to the inner race, it is preferred that the nitriding treatment be performed on the washer so as to form the nitrided layer on the washer.

### REFERENCE SIGNS LIST

1 inner race
1a raceway surface
1b small flange portion
1c large flange portion
1c1 outer peripheral surface
1c2 engagement recess portion
1d inner-race end surface
2 outer race
2a raceway surface
3 tapered roller
4 retainer
5 washer
5a washer body
5b claw portion
5b1 engagement protruding portion
6 mating member
6a flange portion
6a1 flange end surface

1. A tapered roller bearing, comprising:
an inner race having
a conical raceway surface formed as an outer peripheral surface thereof,
a small flange portion formed on a small diameter side of the raceway surface, and
a large flange portion formed on a large diameter side of the raceway surface;
an outer race having a conical raceway surface formed as an inner peripheral surface thereof;
a plurality of tapered rollers rollably interposed between the raceway surface of the inner race and the raceway surface of the outer race; and
a washer for preventing, under a state of being fixed to an end surface on a large flange portion side of the inner race, abrasion of the end surface on the large flange portion side of the inner race and abrasion of an end surface of a flange portion formed on a mating member internally fitted to the inner race, wherein:
the inner race comprises an engagement recess portion provided in an outer peripheral surface of the large flange portion thereof; and
the washer comprises one or a plurality of elastically deformable claw portions formed on an outer peripheral edge thereof and each provided with an engagement protruding portion to be engaged with the engagement recess portion.

2. A tapered roller bearing according to claim 1, wherein the plurality of claw portions are provided at equal intervals along the outer peripheral edge of the washer.

3. A tapered roller bearing according to claim 1, wherein the engagement recess portion is annularly formed over an entire periphery of the outer peripheral surface of the large flange portion of the inner race.

4. A tapered roller bearing according to claim 1, further comprising a gap, under a state in which the engagement protruding portion and the engagement recess portion are engaged with each other, formed between a roller side of the engagement protruding portion and the engagement recess portion so that the roller side of the engagement protruding portion is kept out of contact with the engagement recess portion.

5. A tapered roller bearing according to claim 1, wherein the engagement protruding portion is roundish.

6. A tapered roller bearing according to claim 1, wherein the washer comprises a nitrided layer formed on a surface thereof.

7. A tapered roller bearing according to claim 1, wherein the washer has a plate thickness of from 0.3 to 0.8 mm.

8. A tapered roller bearing according to claim 1, wherein B/A ranges from 0.9 to 2%, where A represents an inner diameter dimension of a part except the engagement protruding portion of the claw portion and B represents a maximum height of the engagement protruding portion of the claw portion.

9. A tapered roller bearing according to claim 1, wherein C/A ranges from 0 to 1.5%, where A represents the inner diameter dimension of the part except the engagement protruding portion of the claw portion and C represents a dimension of a gap between the part except the engagement protruding portion of the claw portion and the outer peripheral surface of the large flange portion of the inner race.

10. A tapered roller bearing according to claim 1, wherein the mating member comprises a pinion shaft of a differential.
